(19) United States
(12) Patent Application Publication
(10) Pub. No.: US 2010/0151915 A1
(43) Pub. Date: Jun. 17, 2010

(54) Headset or Hands-free Set for Mobile Telephones Monitoring Voice Mail Messages in Real-Time and Offering the Option to Take Over Conversation with the Caller

(75) Inventor: Bartholomeus J.F. Huisken, Barcelona (ES)

Correspondence Address: HAYES, SOLOWAY P.C., 175 CANAL STREET, MANCHESTER, NH, 03101, US

(73) Assignee: SOUTHWING, S.L., Barcelona (ES)

(21) Appl. No.: 11/993,548

(22) PCT Filed: May 29, 2006
(86) PCT No.: PCT/EP2006/005103

§ 371 Date: Dec. 21, 2007

(30) Foreign Application Priority Data
Jun. 24, 2005 (ES) P200501547

(51) Int. Cl. H04B 1/38; H04M 1/00

(52) U.S. Cl. 455/567; 455/569.1

(57) ABSTRACT

The present invention refers to a method for monitoring calls to a telephone set, by which a voice message is played back on a speaker of a telephone set at the same time that such message is received by the equipment. The invention also refers to a Hands-Free device or Headsets that are used with mobile telephones and enable users to monitor calls in Whisper Mode, that is, not by directly responding to the caller, but by listening to the message left by the caller in real time while it is being recorded, offering the option to interrupt the process and establish a conversation with the caller. This system can also use a remote server to expand the message storage capacity.

### PURPOSE OF THE INVENTION

The present invention is related to personal communication systems, particularly, hands-free kits and headsets that are used with mobile telephones.

This invention refers to a call monitoring method used in telephone sets. The invention also refers to a Hands-Free device or Headset that are used with mobile telephones and enable users to monitor calls in Whisper Mode, that is, not by directly responding to the caller, but by listening to the message left by the caller in real time while it is being recorded, offering the option to interrupt the process and establish a conversation with the caller.

### BACKGROUND OF THE INVENTION

Presently, mobile telephone users with Hands-Free devices and wired or wireless Headsets provide a limited capacity to manage incoming calls. When a mobile telephone is used, the called party is either available or not available for calls. The impossibility to access the called party can be due to the following reasons: his/her phone is turned off or out of service, is out of coverage or the called party has simply decided not to answer the phone. In these cases and depending on the voice mail services and features of the mobile telephone service number of the called party, the caller can be rerouted to a voice mail service provided by the network operator, or be simply informed that the communication is not possible. The called party or recipient will then be informed through the mobile telephone of a lost call and, in some cases, is notified of a pending message. When using a Hands-Free kit, users have the option to answer or reject the call, being at most informed of the telephone number or name of the caller, with the same results as those described above.

For this reason, the option to monitor the call in real time without having to answer it in a quick and practical fashion is not yet possible in the present state of the art.

Hands-Free Kits and, particularly, Headsets, offer users an excellent opportunity to improve their degree of privacy in the management of their calls. The use of the mobile telephone in silence mode (ringtone off), along with a wired or wireless Headset, enable users that are in presence of other persons to be the only ones to know that they are receiving a call. However, these users are limited to the only option to either accept or reject the call when it takes place, without any other information regarding the call than the identity of the caller, and only in some cases.

Several Headset or Hands-Free kit setups known in the present state of the art are shown in FIG. 2.a-b-c and FIG. 3.a-b-c and are described below: a wired Headset (203) connected through a cable (202) to a mobile telephone (201), as is shown in FIG. 2.a; a wireless Headset (205) interconnected via radio frequency or magnetic induction to a mobile telephone (201) equipped with a wireless access port (204), as is shown in FIG. 2.b; a wireless Headset (207) interconnected via radio frequency or magnetic induction to a mobile telephone (206) equipped with an integrated wireless communication system for personal area communications, as is shown in FIG. 2.c; a wired Headset (2) connected through a cable (208) to a mobile telephone (201), as is shown in FIG. 3.a; a Hands-Free kit (210) interconnected via radio frequency or magnetic induction to a mobile telephone (201) equipped with a wireless access port (204), as is shown in FIG. 3.b; a Hands-Free Kit (211) interconnected via radio frequency or magnetic induction to a mobile telephone (206) equipped with an integrated wireless communication system for personal area communications, as is shown in FIG. 3.c. The radio frequency communications system used can be based, for example, on Bluetooth technology.

### DESCRIPTION OF THE INVENTION

The present invention offers the option to monitor calls in an environment of high privacy in real time, but also giving the chance not to answer the call if it is not necessary. In these environments, the impossibility to know the nature of the incoming call without being obliged to answer it is thus overcome. It is exactly as if someone whispered a message to the user of the system, which is particularly useful in presence of other people who are not to be disturbed or in silence environments, something which was not possible until now. The recipient, after having monitored the call's initial content, can then answer it in real time or reject it, so that the caller can leave a message. The system will inform the caller that the recipient is in Whisper Mode, enabling the caller to leave a message, with the possibility to be replied in real time by the recipient.

A new method and device for Hands-Free kits and particularly for Headsets that are used with mobile telephones is presented, enabling users to monitor incoming calls in real time, with privacy, but also giving the option not to answer the call if it is not necessary. A portable solution is offered, avoiding the inconvenience of not knowing the nature of the incoming call, but with the comfort of not having to answer it. The systems works in a way that the user receives a “whispered notification” of the incoming call, something particularly useful in presence of other people or in environments where silence must be kept, which was not possible so far. This system can also use a remote server to expand the message storage capacity.

According to this, a first aspect of the invention refers to a method for monitoring incoming calls to a telephone set, by which an incoming call is linked to a voice mailbox service to record a voice message. Thus, the method involves playing back the voice message in a speaker of the telephone set at the same time that the message is being received.

Another aspect of the invention refers to an external Headset-type or Hands-Free-type communication device for mobile telephone use, which involves at least a speaker and electronic processing means to manage at least the communication between the device and the mobile telephone itself. The device in characterized in that the electronic processing means are capable of processing a received voice message for the voice mailbox service of the mobile telephone, so that the message can be heard on the speaker at the same time it is received. More specifically, an object of the present invention is a wired Headset that enables the recording of a message in a voice mailbox while it is heard in real time, providing the opportunity to answer the call and speak directly with the caller.

Another aspect of the invention refers to a mobile telephony communication system that comprises the above cited external communication device, linked with a mobile telephone of such system.

### DESCRIPTION OF THE FIGURES

To complement the description of this invention and in order to provide a better understanding of the characteristics of the invention, according to a preferential practical example thereof, an illustrative but not limitative picture game is enclosed as part of this description, depicting the following aspects:

FIG. 1—It shows a flow chart illustrating the typical occurrence of events in a monitoring method that is object of this invention.

FIG. 2—It shows several schematic drawings of setups that are known in the state of the art of a headset and a mobile telephone. In FIG. 2.b, a wireless headset and a mobile telephone with wireless access port are depicted in the use of this application. FIG. 2.c shows the drawing of a wireless headset and a mobile telephone with integrated wireless functionality in the use of this application, while FIG. 3.a shows the drawing of a wired Hands-Free system and a mobile telephone in the use of this application.

FIG. 3—It shows several schematic drawings of setups that are known in the state of the art of a hands-free kit and a mobile telephone. FIG. 3.b shows the drawing of a wireless Hands-Free kit and a mobile telephone with wireless access port in the use of this application. FIG. 3.c shows the drawing of a wireless Hands-Free kit and a mobile telephone with integrated wireless functionality in the use of this application.

FIG. 4—It shows a block diagram of the modules that are part of the communication device in a preferential embodiment of the invention.

FIG. 5—It shows a flow chart of the operation of the device shown in FIG. 4.

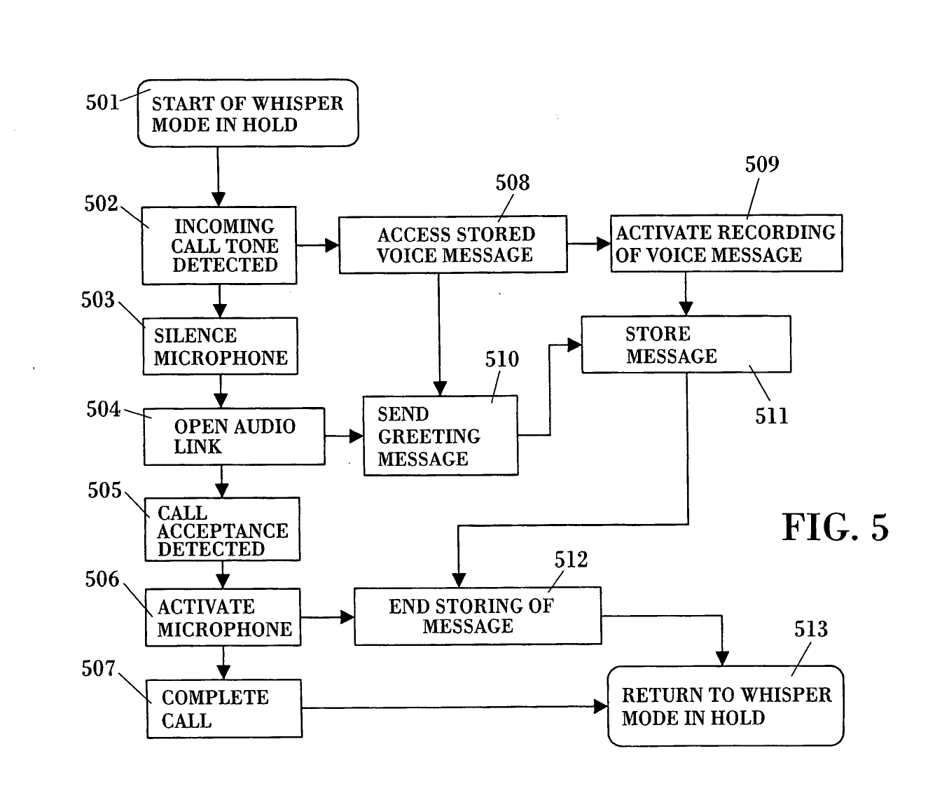

FIG. 6—It shows a block diagram of the elements that make up the communication device in another preferential embodiment of the invention.

FIG. 7—It shows a flow chart of the operation of the system with a remote server for the storage of messages.

### PREFERENTIAL EMBODIMENT OF THE INVENTION

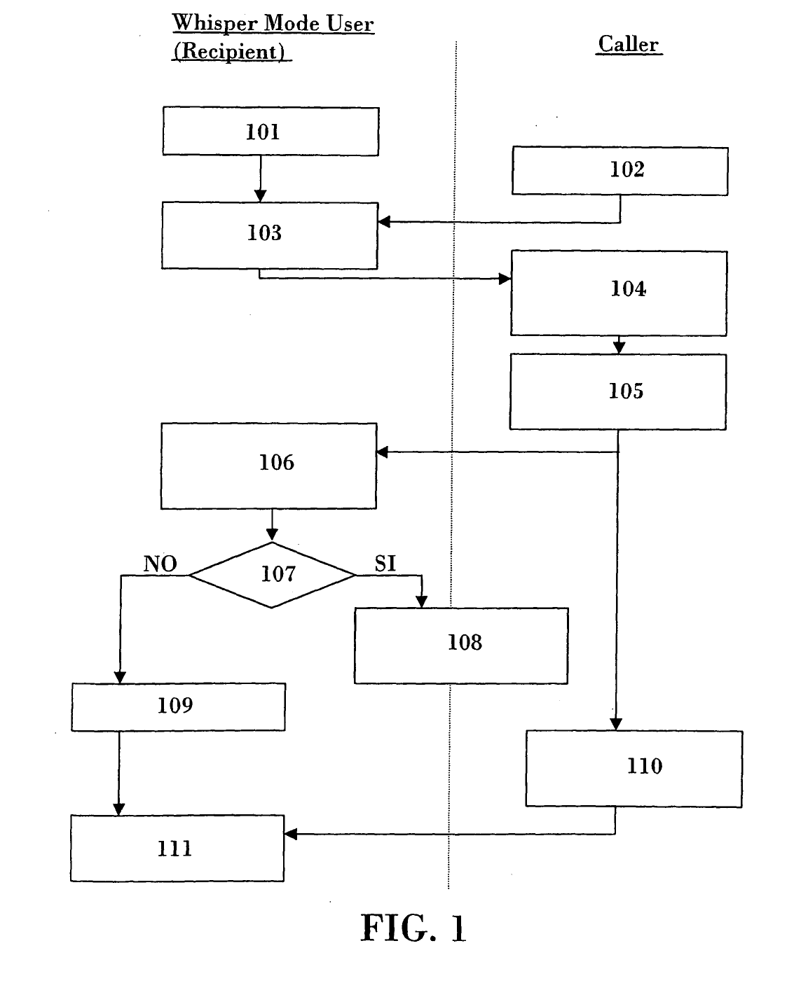

The call monitoring method applied to a telephony equipment was depicted in FIG. 1, and the actions to perform are the following:

(101): The recipient puts its Hands-Free set in Whisper Mode.
(102): The caller starts a call.
(103): The recipient is notified of an incoming call in progress.
(104): The caller is informed that the recipient is set in Whisper Mode and is prompted to leave a voice message.
(105): The caller starts leaving the message (explaining the reason of the call).
(106): At the same time, the voice message starts being played back to be heard by the recipient and the recipient decides if he/she wants to answer the call or not.
(107): Decision to “Answer the call?”
(108): The user and the caller start to talk in a normal conversation.
(109): The recipient rejects the call.
(110): The caller has just left a voice message.
(111): The recipient can play back the message when necessary.

When the user selects this option (101) in the Hands-Free kit and an incoming call is received (102), the user of the system is notified of the existence of the call (103). At the same time, the caller is informed that the recipient is set in Whisper Mode of this application and is prompted to leave a voice message (104): As soon as the recipient starts leaving a message (105), the application user hears the voice (106) while the message is being recorded. The user of the application can decide (107) at that point either to answer the call and start a conversation (108) or reject it (109) and await a better moment to listen to the complete message (111) left by the caller (110).

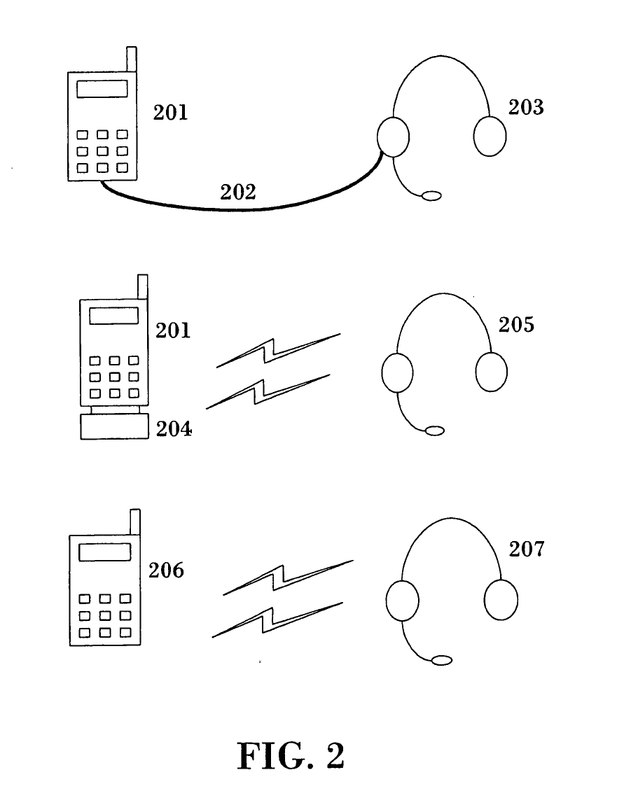

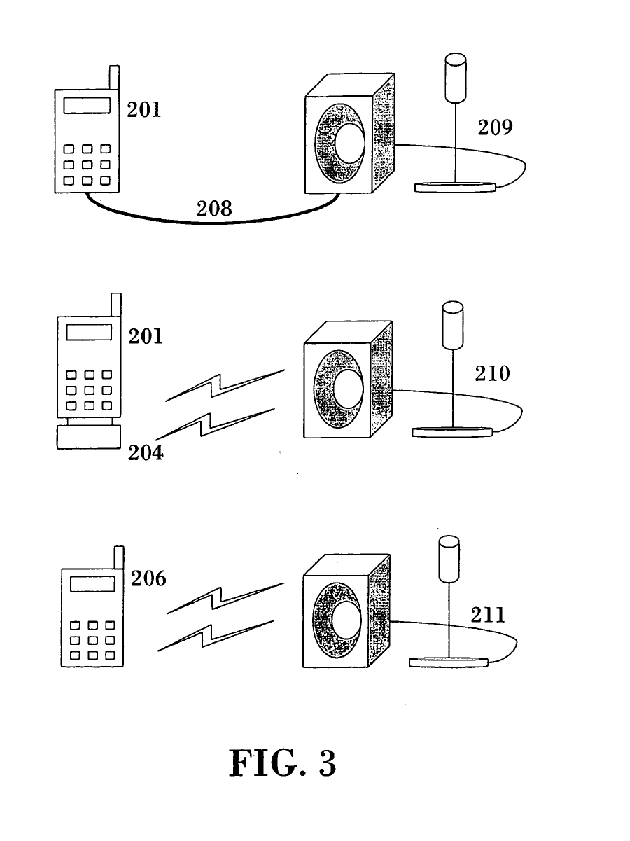

The system for the present invention can be integrated and used in different equipments and setups, for example those shown in FIG. 2.a-b-c and FIG. 3.a-b-c.

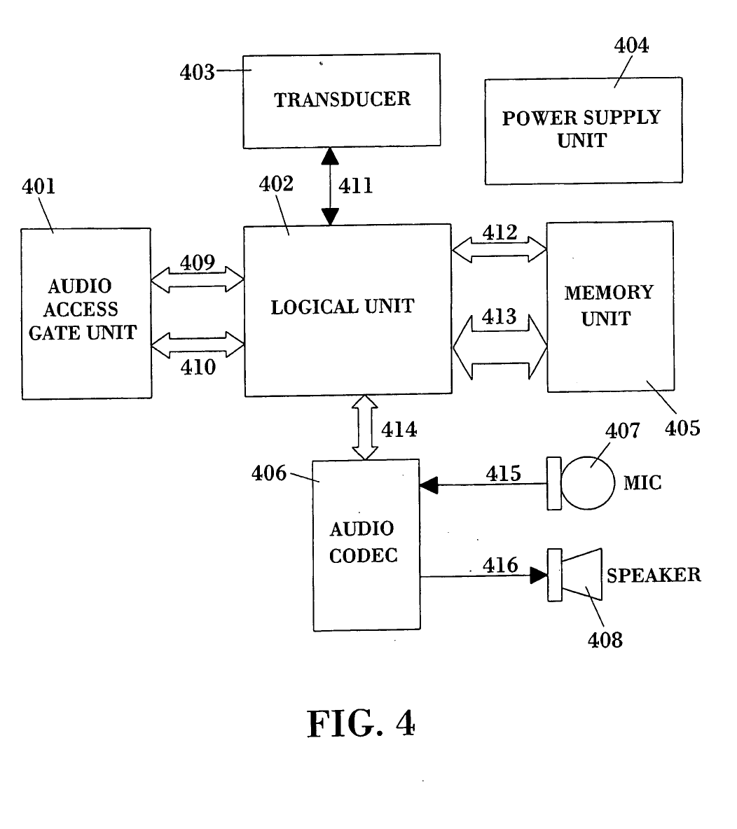

FIG. 4 shows a block diagram of a Hands-Free or Headset type external communications device, according to the present invention. The audio access gate (401) acts like an interface block between the system and the mobile telephone, enabling the transmission and reception of control signals and commands (409), as well as audio signals (410), to the mobile telephone, either through wires or through radio frequency or magnetic induction systems. In the last two cases, this audio access gate can prepare the signals to be transmitted and received in a wireless environment in such cases where the system is connected to the phone in a wireless network, as is shown in FIG. 2.b, FIG. 2.c, FIG. 3.b. and FIG. 3.c.

The power supply unit (404) supplies power to all the active circuits of the system. In a preferential example, this unit is a battery with all the management circuits; in other examples, it can be a DC/DC converter to convert the signals of a direct current supply or an AC/DC converter to convert the signals of an alternating current supply. In other examples, the power supply can be provided by the mobile telephone, as is the case of the wired connection shown in FIG. 2.a and FIG. 3.a.

The device includes electronic processing means (402) that control the whole system and perform all the required functions for its correct operation.

The transducer (403) enables the user to control the system and set it on different operation modes, as the one which is the object of the present invention. In a preferential example, this transducer is a control switch that provides the control signals (411) to the Logical Unit. It can also be another type of device, such as a keyboard or a voice command interpreter. The electronic processing system means (402) control the communication of the Hands-Free kit or Headset with the mobile telephone, activate the different modes selected by the user through the external transducer (403) according to a man-to-machine interface and accomplish the operation functions of the Whisper Mode. The electronic processing system elements (402) were represented in the example shown in FIG. 4 as the logical unit block, with the option to be implemented as a Digital Signal Processor (DSP) or a Microprocessor, although it can also be a Micro-controller or a FPGA logical unit, or a combination of both. In order to operate the system, this unit uses a memory unit (405) that stores the required data in order to run the system. Control signals (412) are exchanged between the memory unit (405) and the logical unit (402) in order to store or recover data (413). This memory unit must be non-volatile and electronically recordable, which in a preferential example is a Flash Memory, but it can also be a RAM memory or a ROM/RAM memory combination, as well as a memory extension (external “memory stick”). The messages stored in the memory can be compressed through several voice signal compression techniques in order to make data storage more efficient.

At least one microphone (407) is used to convert acoustic signals to electrical audio signals (415). At least one speaker (408) is also used to convert electrical audio signals (416) to acoustic signals. In some examples, more speakers and microphones can be used. The Audio CODEC (406) block is used to completely format the electric signals (415) that come from the microphone (407) to data (414) that can be processed by the logical unit (402). The Audio CODEC (406) is also used to decode the formatted data (414) that come from the logical unit (402) to electrical audio signals (416) that are sent to the loudspeaker (408). In a preferential example of this invention, the audio access gate unit (401), the Logical Unit (402) and the Audio CODEC (406) are integrated in the same circuit chip.

The system starts to be operative as soon as the Whisper Mode On Hold (501) is activated. This is accomplished by operating the user commands (411) through the transducer device (403) that are interpreted by the Logical Unit. The Whisper Mode system remains inactive until an incoming call is received. When a call is received, the incoming call tone is detected (502), and the audio access gate unit (401) sends the appropriate control signals (409) to the Logical Unit. At this moment, the user of the Headset or the Hands-Free kit hears the ringing tone. The logical unit then searches for the Greeting Message (508) in the Memory Unit (405). It also silences the microphone (503) and automatically establishes an audio connection (504) with the mobile telephone in order to enable communication with the caller. Until this point, there is no need for the user to interact with the device. The stored data corresponding to the Greeting Message are recovered from the Memory Unit and are decompressed if decompression techniques have been implemented. Then, they are formatted for transmission to the caller (510).

After this, the Logical Unit starts to record the message from the caller. This is done in the following way: the Logical Unit (402) receives the coded audio signal (410), decodes it and sends it to the Audio CODEC (406), so that the user of the system can hear the voice message while it is being recorded in real time. Besides, the Logical Unit formats the incoming signal and eventually compresses it, it controls the Memory Unit for a writing operation (509) and writes the formatted data (511) in the Memory Unit. During the process described above, if at any moment the system receives a preset command from the transducer (411) corresponding to the acceptance of a call (505), the Logical Unit (402) then activates the microphone (506), so that the user and the caller can continue with a normal conversation. At the same time, the incoming message storage process is stopped (512). For this purpose, the Logical Unit interrupts the writing operation in the Memory Unit (413) of the formatted audio signals. At this stage, the Logical Unit acts as in the normal conversation mode. Once the call has ended (507), the system returns to the initial Whisper Mode On Hold.

The user can then play back the stored messages by means of the transducer (403). The appropriate commands (411) sent to the Logical Unit will then start a process in which data are read from the Memory Unit area (405), where one or several messages are stored, and decompresses them and formats them to send them to the Audio CODEC (406) so that the user can hear them through the speaker (408). By means of the transducer (403), the system can skip a message and go on to play back the next message.

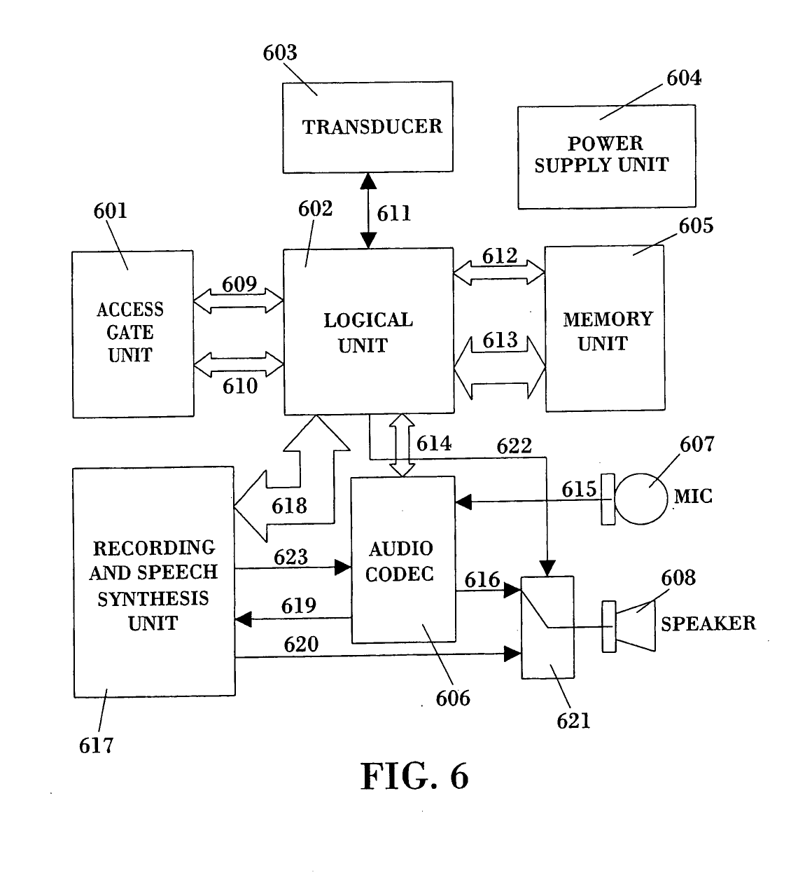

In another embodiment of the invention, an additional circuit block is used to perform some of the specific functions that are required by the system. The functional block diagram of this possible example is shown in FIG. 6. The audio access gate (601) acts like an interface block between the system and the mobile telephone, enabling the transmission and reception of control signals and commands (609), as well as audio signals (610), to the mobile telephone. This audio access gate can at the same time prepare the signals to be transmitted and received by wireless communication in such cases where the system is connected to the phone by a wireless link, as in the case of Bluetooth technology, as is shown in FIG. 2.b, FIG. 2.c, FIG. 3.b. and FIG. 3.c.

The power supply unit (604) supplies power to all the active circuits of the system. In a preferential example, this unit is a battery with all the management circuits; in other examples, it can be a DC/DC converter to convert the signals of a direct current supply or an AC/DC converter to convert the signals of an alternating current supply. In other examples, the power supply can be provided by the mobile telephone, as is the case of the wired connection shown in FIG. 2.a and FIG. 3.a.

The transducer (603) enables the user to control the system and set it on different operation modes, as the one which is the object of the present invention. In a preferential example, this transducer is a control switch that provides the control signals (611) to the Logical Unit. It can also be another type of device, such as a keyboard or a voice command interpreter.

The Logical Unit (602) controls the whole system and performs all the required functions for its correct operation. Therefore, it controls the communication of the Hands-Free kit or Headset with the mobile telephone, activates the different modes selected by the user through the external transducer (603) according to a man-to-machine interface and accomplishes the operation functions of the Whisper Mode. This Logical Unit is in a preferential example a Digital Signal Processor (DSP) or a Microprocessor, but it can also be a Micro-controller, or a FPGA logical unit, or a combination of both systems. In order to operate the system, this unit uses a memory unit (605) that stores the required data in order to run the system. Control signals (612) are exchanged between the memory unit (605) and the logical unit (602) in order to store or recover system management data (613).

This memory unit must be non-volatile and electronically recordable, which in a preferential example is a Flash Memory, but it can also be a RAM memory or a ROM/RAM memory combination, as well as a memory extension (external “memory stick”). The messages stored in the memory can be compressed through several voice signal compression techniques in order to make data storage more efficient. The recording and speech synthesis unit (617) is a circuit block specifically dedicated to the recording and subsequent playback of voice signal data. It consists of an audio CODEC or a Digital Signal Processor dedicated to processing audio signals, non-volatile memory that is electronically re-recordable, and interface control circuit blocks. The Logical Unit (602) controls this block through a set of signals (618). It receives the voice signal data (619) from the Audio CODEC (606) and transmits the stored voice signals (620) to the switch block (621), which are then routed to the speaker (608). The use of a block like this recording and speech synthesis unit (617) leave the rest of the computer resources, signal processing and system memory free to perform functions that are typical of a Headset application or of a standard Hands-Free application.

At least one microphone (607) is used to convert acoustic signals to electrical audio signals (615). At least one speaker (608) is also used to convert electrical audio signals (616) to acoustic signals. In some embodiment examples, more speakers and microphones can be used. The Audio CODEC (606) block is used to completely format the electric signals (615) coming from the microphone (607) to data (614) that can be processed by the logical unit (602). The Audio CODEC (606) is also used to decode the formatted data (614) coming from the logical unit (602) to electrical audio signals (616) to be sent to the speaker (608). These signals pass through a switch block (621) that connects or disconnects the speaker (608) of the Audio CODEC output. In one embodiment example of this invention, the audio access gate unit (601), the Logical Unit (602), the Memory Unit (605) and the Audio CODEC (606) are preferably integrated in the same circuit chip. In this embodiment example, the system starts to be operative as soon as the Whisper Mode On Hold (501) is activated. This is accomplished by operating the user commands (611) through the transducer device (603), which are interpreted by the Logical Unit. The Whisper Mode system remains inactive until an incoming call is received. When a call is received, the incoming call tone is detected (502), and the audio access gate unit (601) sends the appropriate control signals (609) to the Logical Unit (602). At this moment, the user of the Headset or the Hands-Free kit hears the incoming call tone. The logical unit then accesses (618) the Recording and Speech Synthesis Unit (617) and extracts the Greeting Message (623). It also silences the microphone (503) and automatically establishes an audio connection (504) with the mobile telephone in order to enable communication with the caller. Until this point, there is no need for the user to interact with the device. The stored data corresponding to the Greeting Message are recovered from the Speech Synthesizer (617), now in electrical audio format (623). Afterwards, these data are encoded using the Audio CODEC and are routed to the Logical Unit (614) to be then transmitted to the caller (610). After this, the Logical Unit starts to record the message from the caller. This is accomplished in the following way: the Logical Unit (602) controls (622) the Switch Block (621) to enable the connection between the Audio CODEC (606) and the Speaker (608). The Logical Unit receives the encoded Audio signal (610) from the Audio Access gate (601), it processes the signal and sends it to the Audio CODEC (606) that, after decoding it, routes it both to the speaker (608) and the Recording and Speech Synthesis Unit (619), which stores the data. The user of the system can hear the voice message while it is being recorded in real time.

During the process described above, if at any moment the system receives a preset command from the transducer (611) corresponding to the acceptance of a call (505), the Logical Unit (602) then activates the microphone (506), so that the user and the caller can continue with their normal conversation. At the same time, the incoming message storage process is stopped (618). For this purpose, the Logical Unit sends a command (618) to the Recording and Speech Synthesis Unit in order to stop the recording of audio signals. At this stage, the Logical Unit acts as in the normal conversation mode. Once the call has ended (507), the system returns to the initial Whisper Mode On Hold. The user can then play back the stored messages by means of the transducer (603). The appropriate commands (611) sent to the Logical Unit will start a process consisting of a request (618) to the Recording and Speech Synthesis Unit, in order to read the recorded messages. The Logical Unit controls (622) the Switch Block to enable the voice signal (620) that is issued from the Recording and Speech Synthesis Unit to reach the Loudspeaker (608). By means of the transducer (603), the system can skip a message and go on to play back the next message.

Messages can be stored in the Hands-Free or Headset system, and in another performance example of the invention, they can be stored in a remote server. When the user wants to recover the recorded messages, the system starts to play back the new locally-stored messages. After each local message has been played back, the user is given the option to store or delete the message. In the case that the user wants to store the message, it is sent to the remote server or, otherwise, it is deleted from the system. The interaction with the server (707) is required to store or select messages from the server in order to play them back or delete them.

The Headset or Hands-Free system can be controlled by the user by using voice commands. In a possible implementation of the voice mailbox service, by using commands in a distributed speech recognition application, the activation of the service is accomplished by following the steps described below: The user issues a command such as “Voice mailbox” captured by default by the client application. The client system then sends the cepstrum of the digitized voice command to the server by default. After performing the speech recognition and identification of the command, the system activates the remote server. The server then sends a greeting command, indicating the number of messages and the number of new messages to the client in the Whisper Mode located in the Hands-Free or Headset system. When the Client receives the greeting message, it first sends the voice message that contains such command to the user, and is linked to the speech capturing system, awaiting the user to issue the voice commands. The user can then leave the system, hear all the messages from the beginning, or hear new messages. In the interlude between messages, the user has the option to go to the next message, repeat it, go back to the previous message, or delete it.

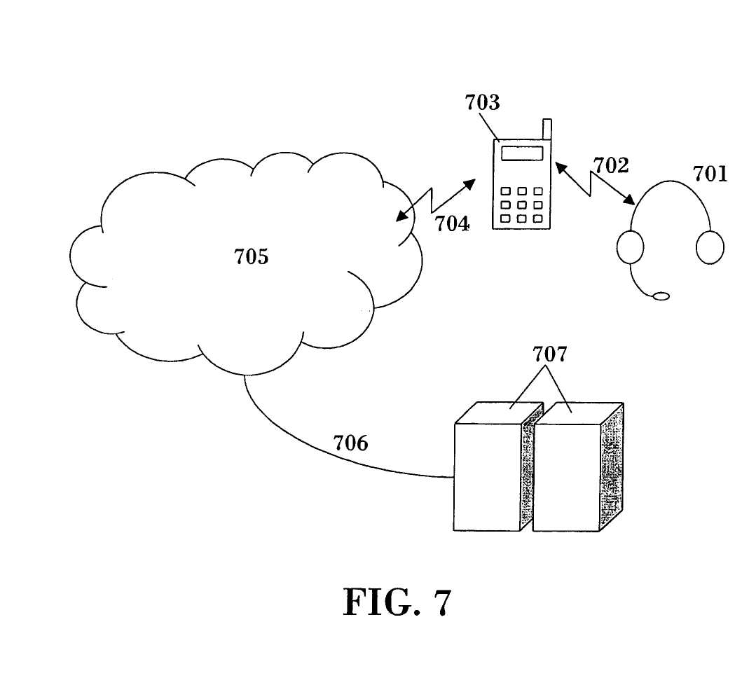

In another example of embodiment, those messages that were recorded can be stored in a remote server of a mobile telephony communication system, in order to expand the storage capacity of the application. FIG. 7 shows an example in which a wireless Headset (701) is connected through radio frequency or magnetic induction (702) to a mobile telephone (703) in order to send via radio frequency (704), over a data network or over a communication network (705) such as GPRS, the encoded and digitized voice messages for their management and storage in remote servers (707).

Several possibilities for practical embodiments of the invention are described in the dependent claims attached.

In view of this description and set of figures, an expert in this field will understand that the embodiments of the invention that have been described above can be combined in multiple ways according to the object of the invention. The invention has been described according to some preferential embodiments thereof, but for an expert in the field it should be evident that multiple variations can be introduced in such preferential embodiments without exceeding the object of the claimed invention.

1. Method to monitor incoming calls to a telephone set, by which an incoming call is linked to a voice mailbox service to record a voice message, characterized in that it comprises playing the voice message on a speaker of the telephone set at the same time that the message is being received on said equipment.

2. Method in accordance with claim 1, characterized in that the telephone set issues an instruction to a calling part that generates the incoming call, informing the calling part that the telephone set is ready to monitor voice messages.

3. Method in accordance with claim 1 or 2, characterized in that such voice message is recorded at the same time that it is being played back.

4. Method in accordance with any of the preceding claims, characterized in that the voice messages are stored in the telephone set or in a remote server.

5. Method in accordance with any of the preceding claims, characterized in that the telephone set consists of a mobile telephone and in that the voice message is played back in a headset speaker or a hands-free device speaker, external to such mobile telephone.

6. External headset-type or hands-free-set-type communication device (701), (209) to be used with a mobile telephone (703), comprising:
at least one speaker (408),
electronic processing means (402) to manage at least the communication between the device and such mobile telephone,
characterized in that the electronic processing means (402) are capable of processing a voice message received by the mobile telephone, so that the message can be played back on the speaker (408) at the same time it is received.

7. Device in accordance with claim 6, characterized in that it contains a memory unit (405) that establishes communication with the electronic processing means (402) in order to store at least such voice messages coming from an incoming call.

8. Device in accordance with claim 6 or 7, characterized in that it comprises an audio access gate unit (401) between the device and a mobile telephone.

9. Device in accordance to any of the claims 6 to 8, characterized in that it comprises means for conversion (406) to convert formatted data (414) coming from the processing system elements (402) into electrical signals that are received by the speaker (408).

10. Device in accordance with any of the claims 6 to 9, characterized in that it comprises a recording and speech synthesis unit (617) to store greeting messages and record voice messages, such unit (617) being linked with the electronic processing means (602).

11. Device in accordance with any of the claims 6 to 10, characterized in that the electronic processing means (402) are selected among the following: i) a digital signal processor, ii) a microprocessor, iii) a micro-controller, iv) a FPGA logical unit, v) any combination of i-iv.

12. Device in accordance with any of the claims 6 to 11, characterized in that it comprises a transducer (403) linked with the electronic processing means (402) in order to enable the user to control the operation of the device.

13. Device in accordance with claim 12, characterized in that the transducer is selected among the following elements: a keyboard, a switch, or voice command interpretation means.

14. Device according to any of the claims 6 to 13, characterized in that at least one audio access gate unit (401) between the device and a mobile telephone, the electronic processing means (402) and the conversion means (406) are integrated in the same integrated circuit.

15. Device in accordance with any of the claims 6 to 14, characterized in that the device consists of: a headset that is wire-connected with a mobile telephone, a wireless headset, a hands-free set with corded connection, or a wireless hands-free set.

16. Mobile telephony communication system characterized in that it comprises a communication device in accordance with any of the claims 6 to 15, linked with a mobile telephone of such system.

17. System in accordance with claim 16, characterized in that it comprises a remote server (707) to store voice messages.
